(19) United States
(12) Patent Application Publication
(10) Pub. No.: US 2012/0049786 A1
(43) Pub. Date: Mar. 1, 2012

(54) BATTERY MANAGEMENT APPARATUS

(75) Inventor: Masayuki KURIMOTO, Kariya-city (JP)

(73) Assignee: DENSO CORPORATION, Kariya-city (JP)

(21) Appl. No.: 13/192,649

(22) Filed: Jul. 28, 2011

(30) Foreign Application Priority Data
Aug. 27, 2010 (JP) 2010-191025

(51) Int. Cl. H02J 7/00

(52) U.S. Cl. 320/106

(57) ABSTRACT

A vehicle carries a battery package as its power source. Plural battery modules in the battery package respectively have a memory device for memorizing identification information that proves authenticity of each of the battery modules. A battery control unit in the vehicle has an authentication unit. The authentication unit determines whether or not each of the battery modules is a compliant battery. When the battery module is determined as non-compliant, a control unit restricts a travel of the vehicle. Under a restricted condition of traveling, damage of the vehicle as well as deterioration of vehicle's reliability due to use of the non-compliant battery are prevented.

### CROSS REFERENCE TO RELATED APPLICATION

The present application is based on and claims the benefit of priority of Japanese Patent Application No. 2010-191025, filed on Aug. 27, 2010, the disclosure of which is incorporated herein by reference.

### FIELD OF THE INVENTION

The present disclosure generally relates to a battery management apparatus used in a battery-driven device which operates on an electric power of a battery.

### BACKGROUND INFORMATION

Conventionally, a battery-driven device which operates on an electric power of a battery is disclosed. Japanese Patent 2008-42985 discloses the battery-driven device, and also discloses to prohibit the charging by the battery when a “use period” of the battery expires. This battery-driven device can restrict use of the expired battery, that is, use of a non-compliant battery.

According to the conventional technique, the user can still use the battery-driven device, as long as an electric power in the non-compliant battery lasts. However, use of the non-compliant battery may deteriorate the reliability of the battery-driven device. In other words, allowing use of the non-compliant battery leads to low reliability of the battery-driven device, which is problematic for the user, as well as for the manufacture of the battery-driven device and the manufacture of the battery. Further, use of the non-compliant battery may highly possibly be continued for a long time.

### SUMMARY OF THE INVENTION

In view of the above and other problems, the present application provides a battery management apparatus, which prevents reliability deterioration when a non-complaint battery is used in a battery-driven device.

The present application uses following techniques for achieving the above-described objectives.

In an aspect of the present invention, a battery management apparatus includes: a battery-checker that determines if a battery in a battery-driven device is compliant or non-compliant; a control unit that controls a functional index of the battery-driven device to a normal output when the battery is compliant; and a restriction unit that controls the functional index of the battery-driven device to a restricted output when the battery is non-compliant, wherein the restricted output is different from the normal output, and the restricted output restricts the use of the battery-driven device when compared to the normal output by the control unit.

According to the above configuration, the battery-driven device is usable even when the non-compliant battery is used. Further, by restricting the function of the battery-driven device, a load for the battery is decreased. As a result, reliability deterioration of the battery-driven device is prevented.

Further the functional index of the battery-driven device includes an operation period and a capacity. Further the restriction unit restricts the operation period or the capacity or both the operation period and the capacity to control the battery-driven device to the restricted output. According to this configuration, the function of the battery-driven device is restricted in terms of at least one of the operation period and the capacity.

Further, the restriction unit shortens the operation period of the battery-driven device when the battery is non-compliant, the operation period is shorter than an operation period set by the control unit. According to this configuration, the operation period of the battery-driven device by using the non-compliant battery is shortened. For example, if the battery-driven device is an electric vehicle, capacity of the vehicle such as a travel period, a travel distance and the like is decreased. Therefore, reliability deterioration of the battery-driven device due to use of the non-compliant battery is prevented.

Further, the battery management apparatus described above further includes: a permission section that permits a battery operation of the battery-driven device until the battery-driven device exceeds the restriction output; and a prohibition section that prohibits the battery operation of the battery-driven device when the battery-driven device exceeds the restriction output. According to this configuration, until the battery operation period exceeds the restriction output, the battery-driven device can be operated. Further, when the battery operation period exceeds the restriction output, the operation of the battery-driven device is prohibited. Therefore, damage of the battery-driven device due to use of the non-compliant battery is prevented.

Further, the restriction unit lowers the capacity of the battery-driven device when the battery is non-compliant, the capacity is lower than a capacity set by the control unit for the normal output. According to this configuration, the capacity of the battery-driven device by using the non-compliant battery is restricted to a low level. For example, if the battery-driven device is an electric vehicle, capacity of the vehicle such as a vehicle speed is restricted to a low level. Therefore, reliability deterioration of the battery-driven device due to use of the non-compliant battery is prevented.

Further, the battery management apparatus described above further includes: a detection section that detects a battery condition; and a configuration section that determines the restricted output based on the battery condition detected by the detection section. According to this configuration, the restriction is set according to the detected battery condition. For example, a period and/or a level may be set as the restriction. Therefore, damage of the battery-driven device due to use of the non-compliant battery is prevented.

Further, the battery management apparatus described above further includes: a compliant battery charge unit that charges the battery when the battery is compliant; and a non-compliant battery charge unit that charges the battery that is non-compliant under a restricted charge condition that is stricter than a charge condition of the compliant battery charge unit. According to this configuration, the non-compliant battery is charged under the restricted charge condition when the non-compliant battery is used. Therefore, damage of the battery-driven device due to use of the non-compliant battery is prevented.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a battery management apparatus in a first embodiment of the present application;

FIG. 2 is a block diagram of a vehicle part of the battery management apparatus of FIG. 1;

FIG. 3 is a flowchart of control of the battery management apparatus in the first embodiment;

FIG. 4 is a flowchart of control of the battery management apparatus in the first embodiment;

FIG. 5 is a flowchart of control of the battery management apparatus in the first embodiment;

FIG. 6 is a flowchart of control of the battery management apparatus in the first embodiment; and

FIG. 7 is a flowchart of control of the battery management apparatus in a second embodiment.

### DETAILED DESCRIPTION

In the following, embodiments of the present application are described with reference to the drawing. Like parts have like numbers in those embodiments, and redundant portions may be omitted from some of those embodiments for brevity. When only a part of the configuration is explained in an embodiment, the rest of the configuration is supplemented by the configuration of preceding embodiments. Combinations of embodiments should not be limited unless expressly restricted or there is hindrance to prohibit the combination.

### First Embodiment

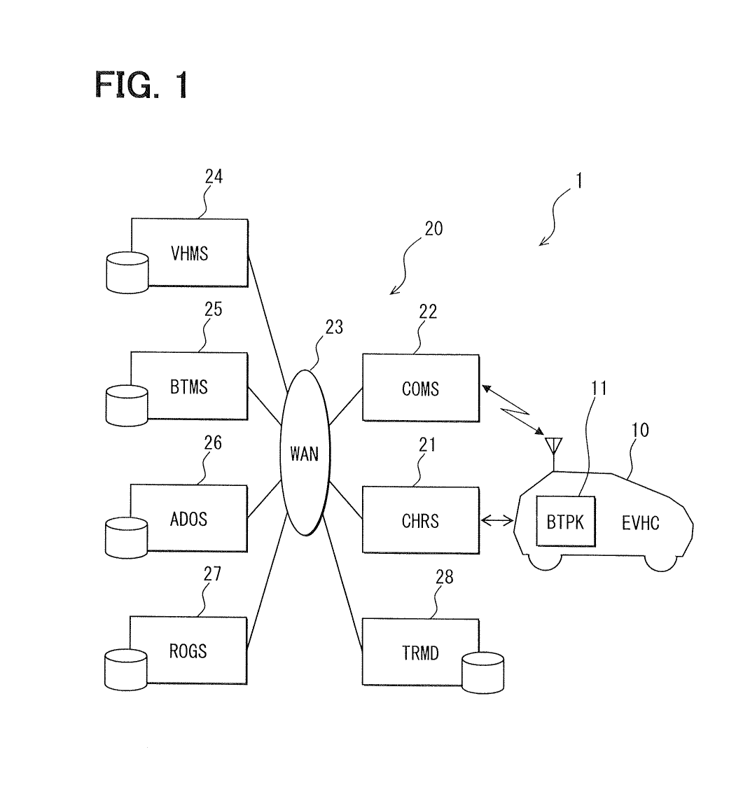

With reference now to FIG. 1 a battery management apparatus 1 comprises a vehicle (EVHC) 10 and a ground facility 20 disposed on the ground. The vehicle 10 is a battery-driven device operated by a battery 11. The vehicle 10 generates at least a part of its driving power by using a motor. For example, the vehicle 10 may be a battery car driven only by a motor, or a hybrid car in which an internal combustion engine is used together with the motor.

The ground facility 20 includes a charge station (CHRS) 21 and a communication facility (COMS) 22. The charge station 21 includes a charger for charging the battery 11 in the vehicle 10 and a data communications equipment to connect to a wide area network (WAN) 23. The communication facility 22 is a communications equipment of a communication company, and is wirelessly communicable with communication equipment in the vehicle 10. For example, the communication facility 22 is a ground station of a mobile telephone service company. The communication facility 22 includes a data communications equipment to connect to WAN 23. WAN 23 serves as a communication line. For example, WAN 23 is provided through Internet.

The ground facility 20 also includes a server of vehicle manufacturers (VHMS) 24, a server of battery manufacturers (BTMS) 25, a server of administrative organization (ADOS) 26, and a server of related organizations (ROGS) 27, which may be referred to as servers 24, 25, 26, 27. Servers 24, 25, 26, 27 are connected to WAN 23. The components of the ground facility 20, that is, charge station 21, the communication facility 22, the server 24, 25, 26, 27, are in mutual communication through WAN 23.

The ground facility 20 may be equipped with an input terminal 28. For example the input terminal 28 may be a personal computer connectable to WAN 23, a portable terminal, or a cellular phone. The input terminal 28 is connectable to the server 24, 25, 26, 27 in the ground facility 20. That is, for example, through communication to the server ADOS 26, the input terminal 28 sets, modifies, or initializes information regarding authentication of the battery 11, together with other processes. The input terminal 28 may be provided as a navigation apparatus including a display unit 15 on the vehicle 10.

The server 24, 25, 26, 27 each include a recording device for recording information provided from WAN 23. The contents of the recording device can be used by the individual servers, and can also be read by a third party. The server VHMS 24 can be read by a manufacturer of the vehicle 10. The manufacturer of the vehicle 10 is an organization related to a battery-driven device, and may be designated as a responsible organization which is responsible for the vehicle 10. The server BTMS 25 can be read by a manufacturer of the battery 11. The manufacturer of the battery 11 is an organization related to the battery, and may be designated as a responsible organization that is responsible for the battery 11.

The responsible organization(s) may be responsible for product liability, a service provision obligation for providing a service that is designated in a contract paper, a social responsibility for preventing an accident and providing relief, together with other responsibilities. For example, the vehicle manufacturer of the vehicle 10 and the battery manufacturer of the battery 11 are considered to bear a few responsibilities regarding their products and its use.

The server VHMS 24 of the vehicle manufacturer has a recording device for recording information provided from WAN 23. The contents of the recording device can be used in the server VHMS 24, and can be read by a manufacturer of the vehicle 10. The server BTMS 25 of the battery manufacturer has a recording device for recording information provided from WAN 23. The contents of the recording device can be used in the server BTMS 25, and can be read by a manufacturer of the battery 11.

The server ADOS 26 can be read by an administrative organization. The administrative organization is an organization related to a battery-driven device or a battery. The administrative organization may be a public organization for substantially administering the responsible organization that is responsible for the vehicle 10 or the battery 11. The public organization includes an organization belonging to a national government or a local government, such as, a governmental organization controlling road traffic, a governmental organization controlling a consumer safety, or the like. The public organization may include a “substantially” public organization, such as, a product authentication organization for authenticating a product such as a battery that has passed a quality test, a performance test or the like. Such an organization may include a non-governmental organization related to a traffic safety or a consumer safety, a non-profit organization, or a corporation. For example, the public organization includes an organization providing security for the vehicle 10 or the battery 11, an insurance company for providing insurance for the vehicle 10 or the battery 11, and an organization for organizing a vehicle user membership. The public organization may further include a non-profit organization that promotes a vehicle safety through public advertisement. These public organizations directly or indirectly control and substantially administer the responsible organizations. That is, the governmental organization controls and administers the vehicle manufacturers and the battery manufacturers based on applicable laws and regulations. Further, the companies and corporations as well as non-profit organizations may also control and administer, through advertisement and information communication to the public, the vehicle manufacturers and the battery manufacturers.

The server ROGS 27 may be read by a related organization, which is an organization related to the vehicle 10 and the battery 11. For example, the related organization may include a police department, an organization related to credit information of the user of the vehicle 10 that provide authentication for personal information of the user, an insurance company providing insurance for the vehicle 10 or the battery 11 may be included in the related organization, or the like.

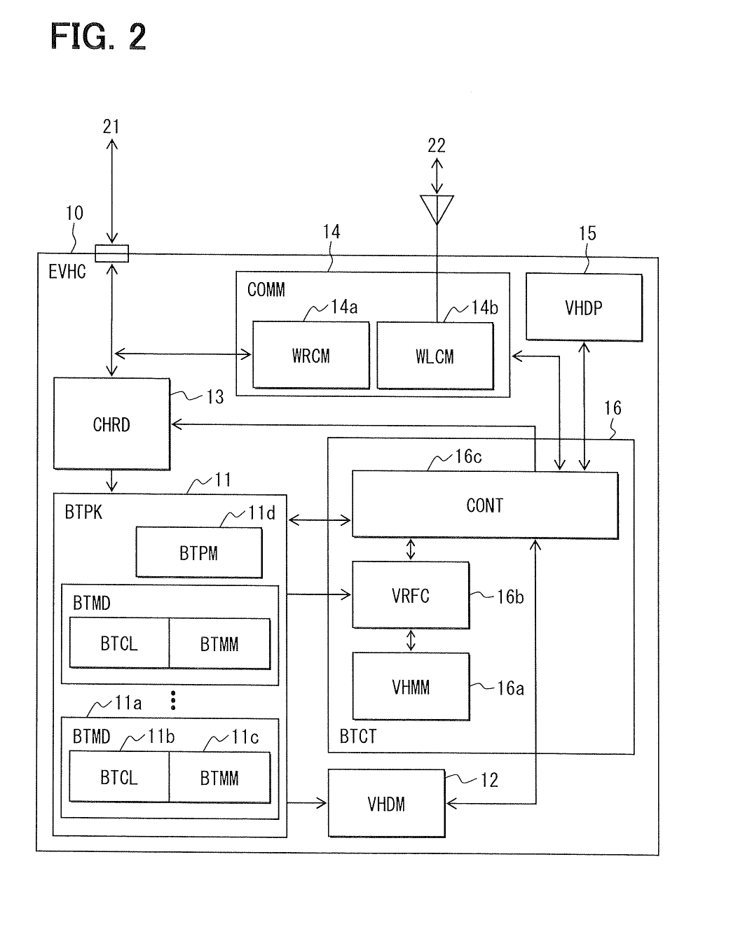

FIG. 2 is a block diagram of a vehicle part disposed in the vehicle 10 of the battery management apparatus 1. In the battery management apparatus 1, the battery 11 is installed in the vehicle 10. The battery 11 may be referred to as battery package (BTPK) 11. The battery package 11 has a plurality of battery modules (BTMD) 11a installed thereon. Each of the battery modules 11a is replaceable. The battery module 11a includes a battery cell (BTCL) 11b and a memory device (BTMM) 11c. The battery cell 11b is a basic component of the battery 11. The battery cell 11b may be a lithium ion battery. The memory device 11c is a part of the battery 11, which cannot be removed from the battery module 11a without breaking it. The memory device 11c memorizes authentication information to authenticate the battery module 11a. The authentication information may include identification information (ID) of the battery module 11a and management information. The identification information may include a code showing that the battery module 11a is a genuine battery and a code showing that the battery module 11a is distributed to an authorized distribution channel. The management information is for managing a use of the battery module 11a compliant to a specification. That is, the management information specifies a warranty period, a maximum number of use, a charge condition, a discharge condition, and the like of the battery module 11a. The memory device 11c memorizes security information related to the battery 11.

Further, the battery package 11 includes a storage device (BTPM) 11d. The storage device 11d memorizes management information about the whole battery package 11. The management information specifies a warranty period, a charge condition, a discharge condition, and the like of the whole battery package 11. Further, the charge condition of the whole battery package 11 specifies, as a condition of restricted charging, a restricted charge amount and a restricted number of charging.

In the vehicle 10, a genuine battery specified by a vehicle maker or a non-genuine battery that is compatible with the genuine battery may be used as the battery 11 or the battery module 11a. For example, the “genuine” battery may indicate a battery that is specified by a maker of the vehicle 10, or a seller of the vehicle 10. Further, the “genuine” battery may indicate a battery that is specified by both the maker of the vehicle 10 and the maker of the battery 11 as a suitable battery for use in the vehicle 10. Furthermore, the “genuine” battery may indicate a battery that is specified by an organization of the makers of the vehicle 10 and/or the makers of the battery 11. The “genuine” battery may include a near-genuine battery that is specified by a public organization, or a near-genuine battery that is specified by an organization of makers and/or sellers. In other words, a battery is proven to be “genuine” not by a label on the battery but by a battery authentication performed by a computer in the vehicle 10.

The non-genuine battery means batteries without warranty, or without authentication by a reliable organization. Those batteries may be designated as a non-compliant battery. The non-genuine batteries may or may not have recorded information on a responsibility of the product (e.g., a product liability), which can be readable by a computer, for identifying a person, a company, or an organization in charge of the battery. Those non-genuine batteries cannot be authenticated by a computer in the vehicle 10. The non-genuine battery may be called as a third party product, or a copy product.

The battery 11 is not considered as “properly-functioning” when the warranty period is expired, or when the maximum times of use is surpassed. That is, even when the battery 11 is a genuine one, the warranty-expired battery or the surpassed max-use-time battery is not considered as “properly-functioning”, and may also be referred to as an “improper battery”. The improper battery are batteries that are not in proper use condition, or are in a no-guarantee condition for use, which may also include a battery that may be broken. The properly-functioning battery can be authenticated by a computer in the vehicle 10. The properly-functioning battery may also be referred to as a proper battery or the like. An improper battery may also be referred to as not properly-functioning battery or the like.

Further, a legally-acquired battery and an illegally-acquired battery are included in a category of the genuine battery. The legally-acquired battery is acquired via an authorized distribution channel, and installed in the vehicle 10 by an authorized procedure. The illegally-acquired battery is a battery acquired illegally from an un-authorized channel or the like. For example, stolen products are categorized as an illegally-acquired battery. The legally-acquired battery can be authenticated by a computer in the vehicle 10.

A “compliant” battery means that a battery is (a) a genuine one, (b) a properly-functioning one, and (c) a legally-acquired one. A non-compliant battery means that a battery is either (d) a non-genuine one, (e) a not properly-functioning one, or (f) an illegally-acquired one. In other words, when a battery is expressed as “compliant” or “normal”, the battery is a genuine one, a properly-functioning one, and a legally-acquired one. When a battery is expressed as “non-compliant” or “abnormal”, the battery is either a non-genuine one, not properly-functioning one, or an illegally-acquired one.

The vehicle 10 has a drive mechanism (VHDM) 12 installed therein. The drive mechanism 12 drives the vehicle 10 on electricity supplied from the battery 11. The drive mechanism 12 includes an electric motor. Further, the drive mechanism 12 may include an internal combustion engine generating a driving power of the vehicle 10.

The vehicle 10 has a charge device (CHRD) 13 installed therein. The charge device 13 controls charging of the battery 11. When the vehicle 10 is connected to the charge station 21 by a charge line, the charge device 13 controls the charging of the battery 11 by the charge station 21. The charge device 13 may have a breaker for permitting and prohibiting the charging of the battery 11 according to an input signal from outside of the charge device 13. The charge device 13 may have a charge amount control unit for controlling the amount the battery 11 is charged. According to the input signal, the charge amount of the battery 11 is controlled to a certain amount between a minimum charge amount and a maximum charge amount according to the input signal.

The vehicle 10 has a communication device (COMM) 14 installed therein. The communication device 14 is in communication with at least one server through a wired connection or a wireless connection. The communication device 14 includes a wired communication device (WRCM) 14a communicating with the charge station 21 through a charge line. Further, the communication device 14 includes a wireless communication device (WLCM) 14b communicating wirelessly with the communication facility 22 through a cellular phone network. The communication device 14 transmits data to an outside server, (i.e., a memory device outside of the communication device 14), through one of the wired communication device 14a or the wireless communication device 14b. The communication device 14 is in communication with at least one of the server VHMS 24 of the vehicle manufacturer and the server ADOS 26 of the administrative organization.

The vehicle 10 has a display unit (VHDP) 15 installed thereon. The display unit 15 displays a message for the user, such as a driver of the vehicle 10. In addition, the user of the vehicle may mean an owner of the vehicle, a manager of the vehicle, a driver of the vehicle, or a passenger of the vehicle. The display unit 15 may be provided as a meter unit, a navigation unit, or an imaging device on the vehicle 10.

The vehicle 10 has a battery control unit (BTCT) 16 installed thereon. The battery control unit 16 is provided as a microcomputer equipped with a computer-readable storage medium. The storage medium stores a computer-readable program. The storage medium may be provided as a memory. The program may be executed by a control unit for controlling the battery control unit 16 to be serving as a device described in this specification. The battery control unit 16 further includes a memory unit (VHMM) 16a, an authentication unit (VRFC) 16b and a control unit (CONT) 16c. These components 16a, 16b, 16c may be provided as a microcomputer circuit and a program executed therein.

The battery control unit 16 controls the battery 11, the drive mechanism 12 and the charge device 13 so that the battery 11 is used properly. The battery control unit 16 is configured to perform the above-described control according to a condition of the battery 11. The battery control unit 16 further performs an authentication control to restrain the use of a non-compliant battery, while preventing inconvenience of to user. The battery control unit 16 has a battery-checker for checking whether a battery is compliant to a maker-specified requirement. Further, the battery control unit 16 controls the charge device and/or the drive mechanism according to a check result of the battery-checker and a transmission unit for sending out relevant information through a communication channel according to the check result of the battery-checker. The above-described function units of the battery control unit 16 may be called as function blocks or modules.

A battery management apparatus 1 includes, as a main component, the battery control unit 16 that may be installed in the vehicle 10. A part of the battery management apparatus 1, such as the battery-checker of the battery control unit 16, can be included in the ground facility 20. Further, information indicative of the use of a non-compliant battery may be configured to be relayed by a plurality of servers, to be stored in an intended recording device. In such a configuration, a part of the transmission unit is installed in the ground facility 20.

The memory unit 16a of the battery control unit 16 memorizes authentication information to authenticate the battery 11. The authentication information, which may also be referred to as the maker-specified requirement, may include a code to authenticate a genuine battery, a code to authenticate a properly-functioning battery, and a code to authenticate a legally-acquired battery.

An authentication unit 16b of the battery control unit 16 serves as the battery-checker for checking whether the battery is compliant or non-compliant based on whether the battery is genuine, properly-functioning, and legal. The authentication unit 16b includes a reader unit for reading the identification information and the management information from the battery 11 as well as a retrieval unit for retrieving the authentication information memorized in the memory unit 16a. The authentication unit 16b determines whether each of the battery modules 11a is compliant or non-compliant.

The authentication unit 16b includes means to determine whether a battery is a genuine or non-genuine battery based on the authentication information and the identification information. The authentication unit 16b determines whether a battery is genuine for each of the battery modules 11a. The determination of whether a battery is a genuine or non-genuine can be determined using various techniques. For example, predetermined identification information is issued only for a genuine battery. The manufacturer of the battery 11 stores the issued information to the memory device 11c. The authentication information is registered in the memory unit 16a. When the identification information accords or is the same as the authentication information, the authentication unit 16b authenticates the battery 11 as a genuine one. When the identification information is not the same as the authentication information, the authentication unit 16b authenticates the battery 11 as a non-genuine one. When the battery module 11a is disposed in the vehicle 10, a code, which should be the same as the identification information, may be registered in the memory unit 16a as the authentication information. By employing a particular procedure or a particular device for reading the identification information from the memory device 11c or for registration of the authentication information in the memory unit 16a, unauthorized registration is prevented.

In another technique, the genuine battery may have the identification information issued with a predetermined encrypting code. The manufacturer of the battery 11 stores the issued identification information to the memory device 11c. The memory unit 16a has a code registered therein as the authentication information for decrypting the identification information. The authentication unit 16b decrypts the identification information by using the registered authentication information, and the decrypted information authenticates the battery as a genuine one when the decrypted information is an expected one. Furthermore, in yet another scheme, predetermined identification information is issued only for a genuine battery. The authentication unit 16b accesses the server ROGS 27 of the related organization through the communication device 14, and determines whether the identification information is of a genuine battery. In this case, the battery-checker is realized as a combination of the authentication unit 16b and the server ROGS 27. The authentication scheme of the genuine battery based on the identification information may be implemented by employing various authentication techniques.

Based on the management information the authentication unit 16b includes a means for determining whether a battery is properly-functioning or not properly-functioning. The authentication unit 16b determines whether a battery is properly-functioning for each of the battery modules 11a. The determination whether or not a battery is properly-functioning can be carried out by the following process. The memory device 11c memorizes warranty information indicative of a warranty period of the battery 11 the management information. The authentication unit 16b determines whether the warranty period has expired. If the warranty period has not expired, the battery 11 is determined as properly-functioning or proper. If the warranty period has expired, the battery 11 is determined as not properly-functioning or improper and is non-compliant. In another process, the memory device 11c memorizes information indicative of a maximum number of charge operations as the management information. The authentication unit 16b determines whether the maximum number of charge operations is surpassed. If the maximum number of charge operations is not surpassed, the battery 11 is determined as properly-functioning. If the maximum number of charge operations is surpassed, the battery 11 is determined as not properly-functioning or improper and as is non-compliant.

Based on the authentication information and the identification information, the authentication unit 16b includes means to determine whether a battery is a legally-acquired or an illegally-acquired battery, and does so for each of the battery modules 11a. The determination whether or not a battery is a legally-acquired battery can be carried out by the following process. A predetermined identification information is issued only for a genuine battery supplied to an authorized distribution channel. The manufacturer of the battery 11 stores the issued identification information to the memory device 11c. When the battery module 11a acquired via the authorized distribution channel is installed in the vehicle 10, predetermined and authorized registration processing is carried out. By the registration processing, the authentication information same as the identification information is registered to the memory unit 16a. When the identification information accords with authentication information, the authentication unit 16b authenticates the battery module 11a as a legally-acquired product. When it does not, the battery module 11a is an illegally-acquired product and is non-compliant. The authentication process of the legally-acquired battery based on the identification information may be implemented by employing various authentication techniques.

Based on the authentication result by the authentication unit 16b, the control unit 16c controls the battery 11, the charge device 13, and the drive mechanism 12. The control unit 16c may provide means to allow or prohibit charging according to the authentication result, means to limit an electricity charge amount according to the authentication result, and means to restrict travel of the vehicle by using the battery 11 according to the authentication result. When a non-compliant battery is used, the control unit 16c and the communication device 14 serve as a transmission unit for sending out, to the external servers VHMS 24, ADOS 26 through WAN 23, information indicative of the use of the non-compliant battery 11.

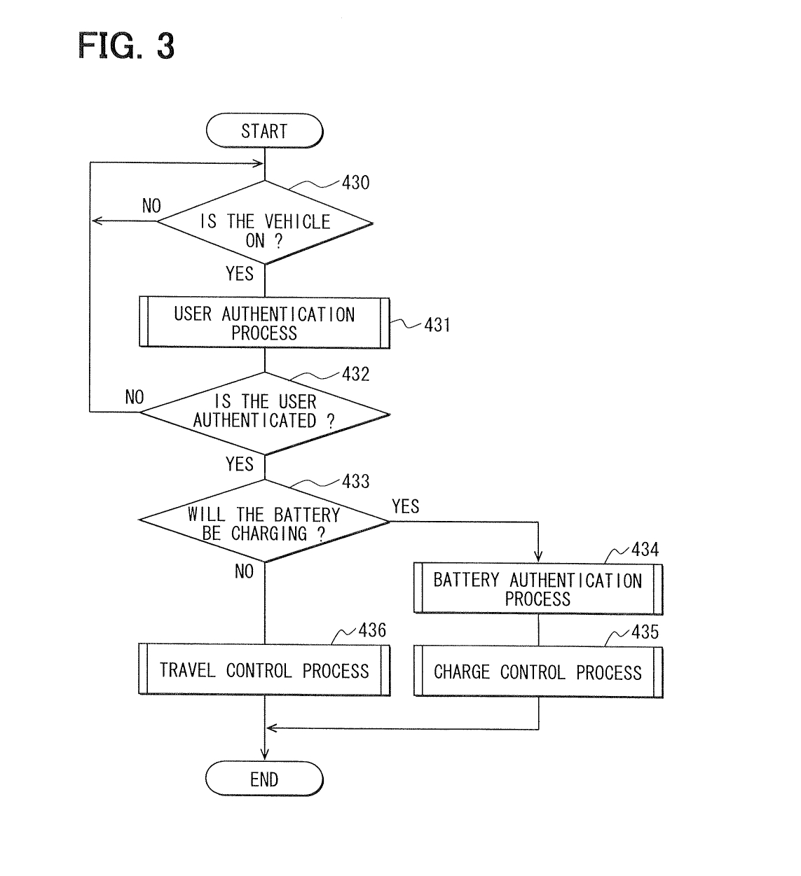

The operation of the battery management system of the first embodiment are explained with reference to FIGS. 3, 4, 5, 6. FIG. 3 is a flowchart showing an operation of the battery management apparatus 1 of the vehicle 10. In step 430 it is first determined whether the vehicle 10 has been started. In other words, when an occupant gets in the vehicle 10, it is determined whether or not a power switch of the vehicle 10 is operated to an “ON” position. When it is determined that the use of the vehicle 10 has not started, the process returns to step 430. When it is determined that the use of the vehicle has started, the process proceeds to step 431. In step 431, a user authentication process is carried out to determine whether the person who is going to use the vehicle 10 has the proper authority. For example, it is determined whether a key or an electronic code used by the user has authenticity. In step 432, it is determined whether use of the vehicle 10 is approved by the user authentication of step 431. When use of the vehicle 10 is prohibited, the process returns to step 430. When use of the vehicle 10 is permitted the process proceeds to step 433.

The user authenticity process in steps 430 to 432 is carried out by a security device belonging to the vehicle 10 or an immobilizer belonging to the drive mechanism 12. Note that the user authentication process in step 431 is different from the battery authentication process in later step 433. Security of the battery information is improved by carrying out the battery authentication process after an affirmative determination in the user authentication.

In step 433, the battery authentication process is carried out. The battery authentication process is carried out by the authentication unit 16b and the control unit 16c. The battery authentication process is explained in more detail later.

In step 434, it is determined whether the user is going to charge the battery 11. When the user stops the vehicle 10 in front of the charge station 21 and connects a charge line to the vehicle 10, the process proceeds to step 435. In step 435, a charge process to charge the battery 11 is carried out. The charge process is carried out by a control unit belonging to the charge device 13. Further, in the charge process, the authentication result from the battery authentication process is referred to, and the charge process is carried out based on the authentication result of the battery 11.

When it is determined that the user is not charging the battery 11, the process proceeds to step 436. In step 436, a travel control process to use the battery 11 as a power source is carried out. The travel control process is carried out by a control unit belonging to the drive mechanism 12. In the travel control process, the authentication result from the battery authentication process is referred to, and the travel control process is carried out based on the authentication result of the battery 11.

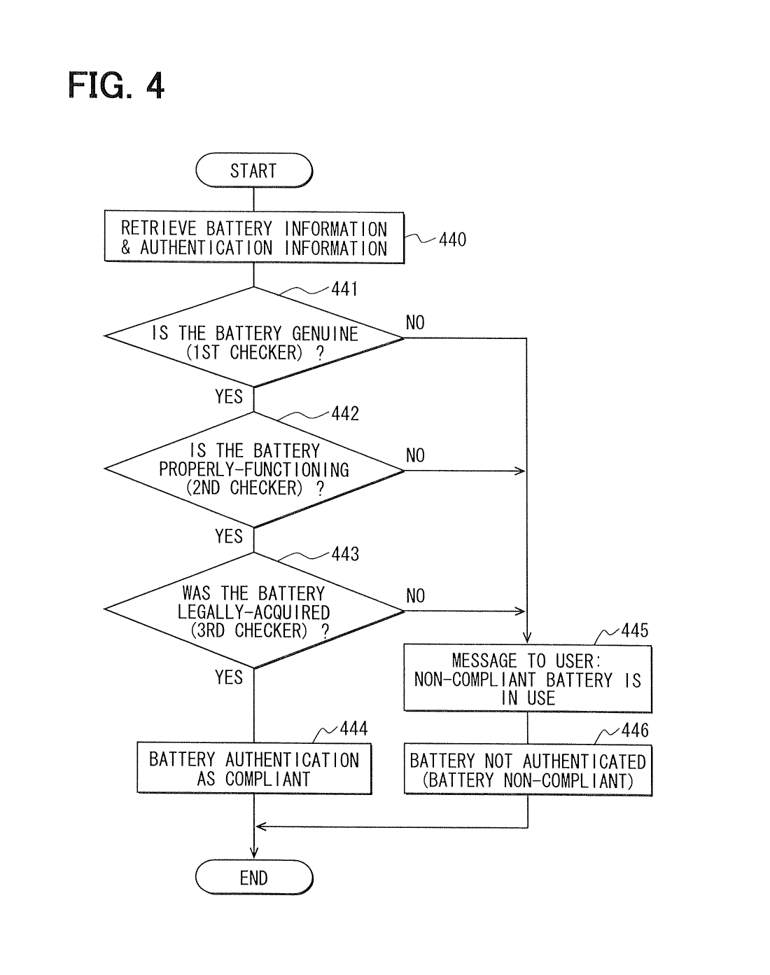

FIG. 4 is a flowchart of the battery authentication process. Steps 440-446 serve as the battery-checker for determining whether the battery 11 is a compliant or non compliant battery. In other words, the battery-checker checks the compliance of the battery 11. In step 440, the identification information and battery information including management information are retrieved from the battery 11. Further, in step 440, the authentication information memorized in the memory unit 16a is retrieved.

In step 441, it is determined whether the battery 11 is a genuine product suitable for the vehicle 10 based on the identification information and the authentication information. For example, this determination can be carried out based on whether a code showing a genuine product is included in the identification information. Step 441 serves as “a first checker” to determine whether a battery is a genuine battery. Step 441 is carried out for each of the battery modules 11a. The process proceeds to step 445 if any one of the battery modules 11a is found to be non-genuine. The process proceeds to step 442 if all the battery modules 11a are genuine.

In step 442, it is determined, based on the management information retrieved from the battery 11, whether the battery 11 is properly-functioning. Step 442 serves as “a second checker” to determine whether a battery is properly-functioning. Step 442 is carried out for each of the battery modules 11a. The process proceeds to step 445 when any one of the battery modules 11a is found to be not functionally-proper. The process proceeds to step 443 if all the battery modules 11a are genuine.

In step 443, it is determined whether the battery 11 is a legally-acquired battery. In other words, it is determined if the battery 11 is acquired via the authorized distribution channel, and it is determined whether the battery 11 is installed in the vehicle 10 by an authorized procedure. For example, this determination can be carried out by determining whether the identification information is associated with the information that is unique to the vehicle 10. Step 443 serves as “a third checker” to determine whether a battery is legally acquired. Step 443 is carried out for each of the battery modules 11a. The process proceeds to step 445 when any one of the battery modules 11a is found to be illegally-acquired.

If the process determines in step 443 that all the battery modules 11a are legally-acquired, the battery 11 is determined as a compliant or a normal battery because it was determined as genuine in step 441, as properly-functioning in step 442, and as legally-acquired in step 443. Thus, in step 444, it is recorded that the battery 11 is authenticated as compliant. In other words, when the step 444 is carried out, the battery is a normal one. Because the battery is determined as normal, a normal charge control for the battery 11 and a normal travel control for the vehicle 10 are permitted thereafter.

When the battery 11 is determined as non-genuine in step 441, or as not properly-functioning in step 442, or as illegally-acquired in step 443, the battery 11 is considered to be a non-complaint or abnormal battery. Therefore, in steps 445 and 446, a countermeasure process is performed.

In step 445, the user of the vehicle 10 is notified of the use of the non-compliant battery 11 by displaying a message to the user on the display unit 15. In step 446, non-authentication of the battery 11 is memorized. That is, the fact that the battery 11 is a non-compliant battery is memorized in step 446. In other words, when step 446 is performed, the battery is non-compliant. Thus, a countermeasure control configured to restrain the use of the non-compliant battery 11 is performed. The countermeasure control is, for example, provided as a restricted charge control for charging the battery 11, where the restricted charge control is different from the normal charge control.

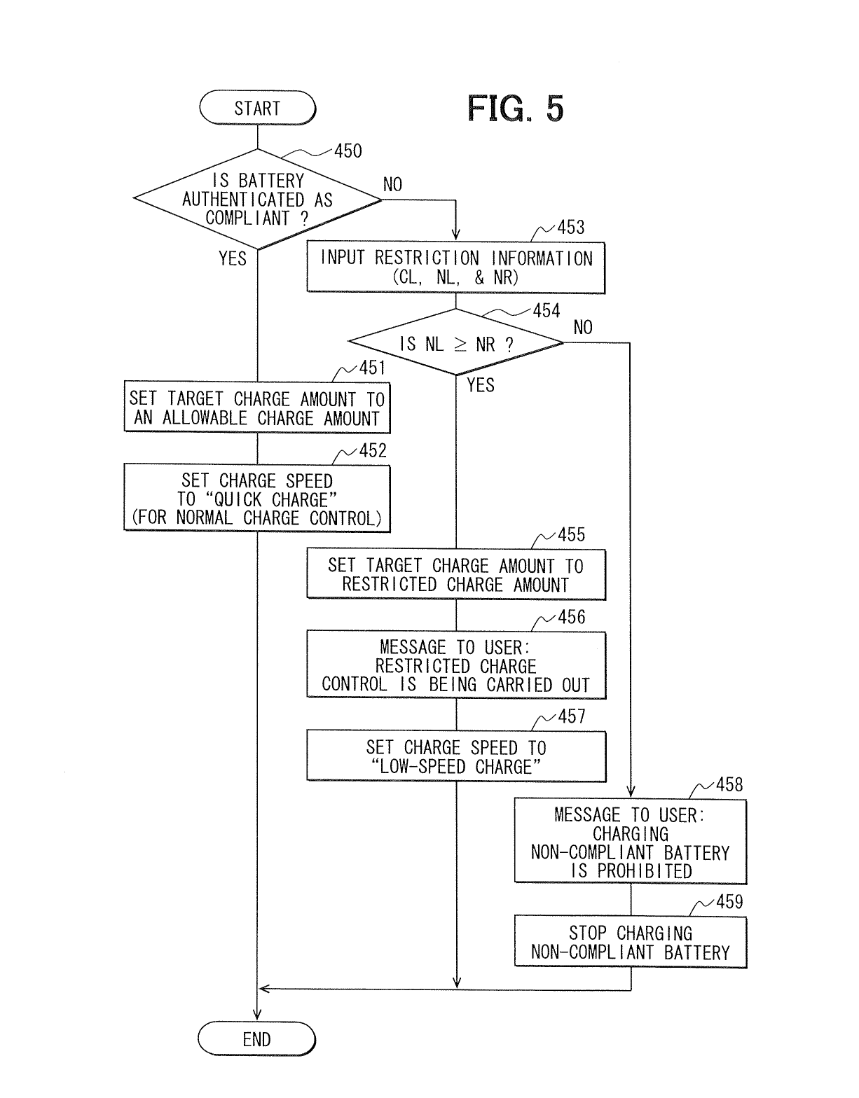

FIG. 5 is a flowchart of a charge control process. In step 450, it is determined whether the battery 11 is authenticated. In the determination in step 450, the authentication result in step 444 or step 446 is referred to. When the battery 11 has been authenticated as a compliant battery, steps 451 and 452 are performed for a normal charge control, and a regular charger for charging the battery under a normal charge control is provided.

In step 451, a target charge amount is set. In step 451, the target charge amount is set to an allowable charge amount (CP), which is the maximum amount of charging of the battery 11. The target charge amount is set according to charging indices of the battery 11, or according to charge-related indices of the battery 11. For example, a battery capacity Ah may be used as one of the charging indices. In such a case, an allowable maximum capacity BvehMax of the battery 11 may be set as the target charge amount. The battery capacity is unique to the battery 11, or to the battery modules 11a. The allowable charge amount (CP) is storable in the battery control unit 16. The allowable charge amount (CP) may also be stored in the memory device 11c of the battery module 11a, or in the memory device 11d of the battery 11.

In step 452, the battery 11 is quick-charged to the target charge amount by the charge device 13. If the charge is interrupted by the user, the battery 11 is not charge to the target charge amount. However, the battery 11 is charged quickly by the quick charge. The “quick charge” is a charge speed that is greater than the charge speed of the restricted charge control described later. Therefore, the speed of the quick charge may not necessarily be limited to the maximum charge speed. In the normal charge control including steps 451 and 452, the user is capable of charging the battery 11 to an allowable maximum charge amount. In other words, when the compliant battery is used, the user can charge the battery 11 in an unlimited manner within an allowable range.

In step 450, if the battery 11 is not authenticated as compliant, in other words is a non-compliant battery, then the restricted charge control is carried out in steps 453-457. Under the restricted charge control, an irregular charger to charge the battery 11 is usually provided.

The restricted charge control is different from the normal charge control. The restricted charge control provides inconvenient charge for the user in comparison to the normal charge control. For example, a restricted charge amount in the restricted charge control is set to be smaller than a normal charge amount in the normal charge control. In such a case, the irregular charger charges a battery to the restricted charge amount that is smaller than the amount charged by the regular charger. The restricted charge control is not configured to restrict the amount of charge to zero. In the restricted charge control, the battery 11 can still be charged. However, the restricted charge amount is smaller than the allowable charge amount (CP) for the battery 11, or the charge amount that is acceptable/permissible to the battery 11. Further, the restricted charge amount is set to allow the user to drive the vehicle 10 for a certain distance. In such a case, the user can still drive the vehicle 10 for a limited distance by charging the battery 11 to the restricted charge amount. In addition, the user is prompted to switch to a compliant battery.

The restricted charge control may be configured to require more time to charge the battery 11 than the normal charge control. Such restriction on the charge speed may be imposed by itself, or may be imposed in combination with other restrictions of the restricted charge control. More practically, the quick charge is prohibited and only a slow-speed charge is permitted. In such a case, the irregular charger charges the battery 11 at a restricted charge speed that is slower than a charge speed by the regular charger. Therefore, the user can still drive the vehicle 10 by charging the battery 11, with certain inconvenience imposed on the user. In addition, the user is prompted to switch to a compliant battery.

Further, the number of times the battery 11 can be charged can be restricted in the restricted charge control, and is referred to as a restricted number of charge times. The restricted number of charge times is substantially smaller than the number of charge times that the battery 11 can endure by specification. For example, the restricted number of charge times may be set to several times, such as 2, 5, 10 or so, but not zero. In such a case, the irregular charger permits the charge under the restricted charge condition for only a predetermined number of times. Therefore, by restricting the number of charge times, the use of the non-compliant battery by the user can be restrained, with certain inconvenience imposed on the user.

In step 453, the control unit 16c inputs restriction information required for the restricted charge control. For example, the control unit 16c retrieves the management information of the battery 11 from the memory device 11d. In the memory device 11d, the management information of the battery 11 is memorized. The restricted charge amount (CL) and the restricted number of charge times (NL) are included in the management information. When the management information of the battery 11 cannot be retrieved from the memory device 11d, a stored default value is used by the memory unit 16a. The restricted charge amount (CL) is set in advance, in consideration of a characteristic of the vehicle 10 and the performance of the battery 11 which is installable in the vehicle 10, and it is memorized in the memory device 11d of the battery 11.

The restricted charge amount (CL) may be configured to allow the vehicle 10 to travel only for a predetermined distance or only for a predetermined time. The above-described predetermined distance or time may be set to prevent the user to suffer an intolerable disadvantage. For example, the restricted charge amount (CL) may be set to allow the user to drive the vehicle 10 to a service factory after it is determined that the battery 11 is a non-compliant battery. The restricted charge amount (CL) can be set to be less than 50% and more than 10% of the capacity of the battery 11. For example, the restricted charge amount (CL) may be set to a smallest capacity BvehMin in advance.

The control unit 16c inputs an allowable number of charge times (NR), which is the number of times the battery 11 had been charged after the battery 11 is determined as non-compliant as long as the non-compliance persists. The allowable number of charge times (NR) may be memorized as one of the management information in the memory device 11d.

In step 454, it is determined whether the allowable number of charge times (NR) is equal to or smaller than the restricted number of charge times (NL). If the allowable number of charge time is equal to or smaller than the restricted charge number of charge time (NR), then the non-compliance battery 11 can be recharged under the restricted charge control. If the allowable number of charge time is not equal to or smaller than the restricted charge number of charge time (NR), then the non-compliance battery 11 cannot be charged. In other words, whether the allowable number of charge times (NR) after the determination of non-compliance still remains is determined. When the allowable number (NR) still remains, the process proceeds to step 455.

In step 455, the target charge amount is set. In step 455, the restricted charge amount (CL) is set to the target charge amount. Because the restricted charge amount (CL) is set in advance based on the capacity of the battery 11, the restricted charge amount (CL) set in the above-described manner is appropriate for preventing a trouble, even when the non-compliant battery is used.

In step 456, the user of the vehicle 10 is notified of the restricted charge control due to the use of the non-compliant battery. That is, a warning message indicating that the restricted charge control is carried out and is displayed on the display unit 15. Furthermore, contents of the restricted charge control may be displayed on the display unit 15. For example, the restricted charge amount (CL) and/or expected travelable distance are displayed. Furthermore, in step 456, a difference between the restricted number of charge times (NL) and the allowable number of charge times (NR) may also be displayed on the display unit 15. The difference between the restricted number of charge times NL and the allowable number of charge times NR is the remaining number of times the non-compliant battery 11 can be charged. Step 456 serves as a display unit for displaying that the charge of the battery 11 is performed by the irregular charger.

In step 457, the speed at which the charge device 13 charges the battery 11 to the target charge amount is set to a low speed charge. The charge speed of the low-speed charge is slower than the charge speed of the quick charge under the normal charge control. Therefore, the charge speed of the low-speed charge is not limited to the lowest charge speed. The user can charge the battery 11 to the restricted charge amount (CL) of the battery 11 in steps 453 to 457. In other words, the user can charge the battery 11 under a predetermined restricted charge condition when a non-compliant battery is used.

Furthermore, a charge prohibition control is carried out in step 258 and step 259 when the restricted charge control is carried out for the predetermined number of times. Steps 458 and 459 serve as a charge prohibition unit. When it is determined that the allowable number of charge times (NR) exceeds the restricted number of charge times (NL) in step 454, the process proceeds to step 458. In step 458, the user of the vehicle 10 is notified that the charging of the battery 11 is now prohibited. That is, step 458 displays a warning message on the display unit 15 that the charging of the battery 11 is prohibited. In step 459, the charging is actually prohibited. That is, in step 459, the charging of the battery 11 by the charge device 13 is stopped.

In the present embodiment, a battery can still be charged when a non-compliant battery is used. Therefore, the battery-driven device is still in a drivable/operable condition. In addition, by restricting the amount of charge or by restricting the charge speed, a certain amount of inconvenience is imposed on the user. Therefore, the convenience of the user is improved while restraining the use of the non-compliant battery.

According to the present embodiment, the battery 11 can be charged even when the battery 11 is a non-compliant one. Therefore, the battery-driven device is usable by the electric power of the non-compliant battery. Further, by restricting charge conditions such as a charge amount and/or a charge speed, the user convenience is restricted by a certain amount. Therefore, the user convenience is improved at the cost of certain restriction, in comparison to, for example, prohibition of charging the battery 11 and/or prohibition of travel of the vehicle by using the non-compliant battery. Further, by restricting the charge condition, damage of the battery-driven device due to use of the non-compliant battery is prevented.

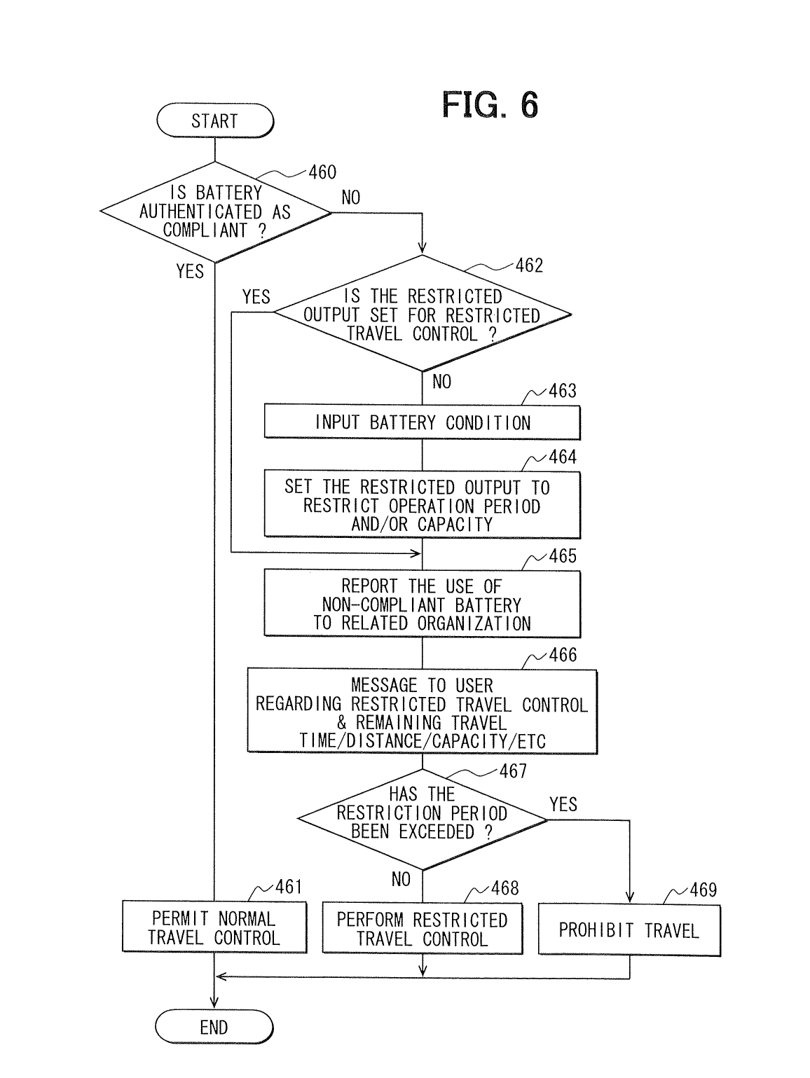

FIG. 6 is a flowchart of a travel control process. In step 460 the process determines if the battery 11 was authenticated as compliant by referring to the authentication result stored in step 444 or 446 of FIG. 4. If the battery 11 is authenticated as a compliant battery, a normal travel control is performed in step 461. Step 461 serves as a control unit that controls the battery-driven device at a normal travel control by setting a functional index of the battery-driven device to a normal output. The control unit may be considered as a travel control unit for performing the normal travel control when the battery 11 is compliant. The normal travel control in step 461 allows the user to use an allowable maximum capacity of the battery 11 for driving the vehicle 10. In other words, the battery 11 is utilized in full capacity within an available range by the user of the vehicle.

If the battery 11 is not authenticated as a compliant battery (i.e. the battery is non-compliant) a restricted travel control is performed in steps 462 to 468. Steps 462 to 468 serve as a restriction unit that controls the battery-driven device at a restricted travel control by setting the functional index of the battery-driven device to a restricted output. In the present embodiment, the output of the battery 11 that serves as a power source of the vehicle 10 is restricted by limiting travel-related function of the vehicle 10.

In step 462, once the battery 11 is determined to be non-compliant the process determines whether the restricted output has been determined. If the restricted output has not been determined, the restricted output is set in steps 463 and 464. If the restricted output has been determined, the process proceeds to step 465.

In step 463, a condition of the battery 11 is inputted. The condition of the battery 11 may include the management information from the memory devices 11c, 11d. For example, a time after an expiration date of the battery 11 may be inputted as the condition of the battery 11. Further, the condition of the battery 11 may include observation information such as an electric voltage, an electric current, and a temperature of the battery 11. Step 463 serves as a detection section in the restriction unit that detects a condition of the battery 11.

Based on the condition of the battery 11, the process, in step 464, sets the restricted output. The restricted output is set for maintaining reliability of the battery 11. More practically, the restricted output is set to prevent possible damage due to use of the non-compliant battery. Step 464 serves as a configuration section in the restriction unit that sets the restricted output according to the condition of the battery 11.

The restricted output is set based on the functional index that is used to measure a travel function of the vehicle 10, which may include an integral index or a temporal index. The integral index may be designated as an operation period of the vehicle 10. The operation period may include, a travel period, or a travel distance, or the like. The temporal index may be designated as a capacity of the vehicle 10. The capacity may include a travel speed, or an acceleration, or the like. Therefore, in step 464, the restricted parameter sets either or both the operation period and the capacity of the vehicle 10 in order to perform the restricted travel control.

By restricting the functional index of the vehicle 10, the period of time that the battery 11 is being used or the amount of power being absorbed from the battery 11, which is non-compliant, is indirectly restricted. The restricted output restricts or stops the use of the battery 11 even when electric power is remaining in the battery 11. In other words, the restricted output, is not a passive restriction that allows the vehicle 10 to use the power of the battery 11 until the electric power of the battery 11 is exhausted. Likewise, the restricted output, is not a passive restriction that allows the vehicle 10 to use the full capacity of the battery 11.

The restricted output may restrict the operation period of the vehicle 10 that includes the travel distance and/or the travel time of the vehicle 10. When the battery 11 is expired the operation period provides the battery 11a grace period or serves as an extension of time for the vehicle 10 to continue to use the battery 11. The extension of time may be configured to be substantially shorter than the use period of the battery 11. The extension of time may be set by the vehicle manufacturer or the battery manufacturer. For example, the extension of time may be set to a period of time, such as several hours, several days or the like. The extension of time may be set in consideration of the travel distance or the travel time required for the vehicle 10 to reach a service factory.

The restricted output may also restrict the capacity of the vehicle 10. For example, the travel speed of the vehicle 10 may be restricted to 60 km/h. In this manner, the load placed on the battery 11 by the vehicle 10 is restricted, thus restricting the amount of power used from the battery 11. Further, the operation period may be used in combination with the capacity. For example, the restricted output may be set in a form of a predetermined operation period in combination with a predetermined travel distance range and a predetermined maximum travel speed.

In step 464, the condition of the battery 11, which is used to determine the restricted output, may be based on whether the battery 11 was found to be non-genuine, not properly-functioning or illegally acquired. For example, when the battery 11 is suspected to be illegally acquired, use of the battery 11 may preferably be prohibited without delay. Meaning, the restricted output may set the travel distance or the travel time of the operation period to zero. Further, when the battery 11 is found non-compliant because it is non-genuine or illegally acquired the travel period, the travel distance, or the travel speed may preferably be controlled in a strict manner. That is, the output of the non-genuine or illegally acquired battery may be more strictly restricted than the output of the battery 11 that is expired, which means it is not properly-functioning, but is genuine and legally acquired.

In step 465, use of the battery 11 that is non-compliant is reported to the related organization. Reporting to the related organization is performed as transmission of predetermined information to the servers 24, 25, 26, 27 in the related organization, and as storage of the information in those servers.

In step 466, the process notifies the user of the vehicle 10 on the restriction placed on the travel control because of the use of a non-compliant battery. Step 466 displays a warning message regarding the restricted travel control on the display unit 15. Further, contents of the restricted travel control may be displayed on the display unit 15. Further, a remaining amount of the restriction, such as a remaining operation period, a remaining output power, a remaining travel distance and the like may be displayed. If the remaining amount of the restricted output is equal to zero, the prohibition of travel of the vehicle 10 is displayed in step 469, which is described later.

In step 467, the process determines whether battery-driven device has exceeded the restriction output, which allows the battery-driven device to use the battery 11 that is non-compliant for a limited time or for a limited capacity. That is, whether use of the non-compliant battery after determination of use of the non-compliant battery has reached the limit of the restriction output, or the permission period. For example, if the restriction output sets the travel distance of the operation period to 50 miles for the non-compliant battery, step 467 determines if the battery-driven device has exceeded the 50 miles. If the limit of the restriction has not been reached the process proceeds to step 468. If the limit of the restriction has been reached the process proceeds to step 469. The process in step 467 may serve as a period determination unit, which determines if the travel period of the vehicle 10 has exceeded a travel restriction period of the restricted output. The process in step 467 may serve as a distance determination unit, which determines if the travel distance of the vehicle 10 has exceeded a restriction distance of the restricted output. The process in step 467 may be provided as a “logical sum” or a “logical multiplication” of determinations of the above-described two determination units.

In step 468, the drive mechanism of the vehicle 10 is operated under the restricted output set in step 464. That is, the restricted travel control is performed. Step 468 allows travel of the vehicle 10 while a travel capacity of the vehicle 10 is restricted. For example, the travel speed of the vehicle 10 is restricted within a predetermined range of restricted speed.

Once the vehicle 10 has exceeded the restriction of the restriction output, the process, in step 469, prohibits the travel of the vehicle 10. As a result, the operation period of the vehicle 10 by using the non-compliant battery is made shorter than an operation period that is permitted by using a compliant battery.

Steps 467 to 469 serve as the restriction unit that restricts the function or performance of the battery-driven device when the battery-checker determines that the battery 11 is non-compliant. The restriction unit may be designated as a travel control unit of a non-compliant battery for performing a restricted travel control. Further, the restricted unit restricts the function of the battery-driven device by putting restriction on at least one of the operation period and the capacity of the battery-driven device. That is, the operation period of the battery-driven device is shorter under the restricted travel control than the operation period allowed under normal travel control set by the control unit. For example, a travelable period of the vehicle 10 and/or a travelable distance of the vehicle 10 is shortened by the restriction unit to perform the restricted travel control, when compared to the travelable period and travelable distance set by the control unit for the normal travel control. As another example, the travel speed and/or the acceleration of the capacity of the vehicle 10 is reduced by the restriction unit when compared to the travel speed and/or the acceleration set by the control unit.

Steps 467 and 468 may be considered as a permission section in the restriction unit for permitting a battery operation of the battery-driven device until the battery-driven device exceeds the restriction output. Steps 467 and 469 may be considered as a prohibition section in the restriction unit for prohibiting the battery operation of the battery-driven device when the battery-driven device exceeds the restriction output. The prohibition section is configured to shorten the operation period of the battery-driven.

According to the travel control of the present embodiment, the vehicle 10 is travelable even when the non-compliant battery is used. Further, after determination of use of the non-compliant battery, the travel of the vehicle 10 is restricted, in terms of at least one of the operation period and the capacity. Further, after determination of use of the non-compliant battery, the degree of restriction is determined according to the condition of the battery 11. Therefore, the load placed on the battery 11 is restricted. As a result, damage due to use of the non-compliant battery is restricted. Further, even when the non-compliant battery is used, reliability deterioration of the vehicle 10 is prevented.

### Second Embodiment

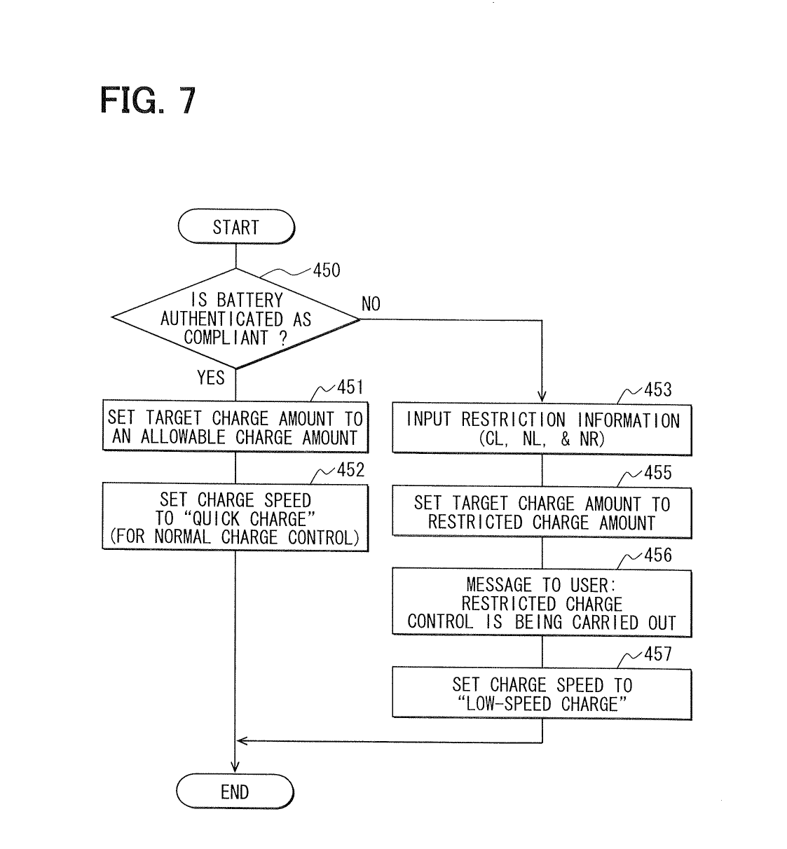

In the second embodiment, the charge control process in FIG. 5 of the previous embodiment is replaced with a process in FIG. 7. The system configuration in FIGS. 1 to 4 and 6 is used in common with other embodiments.

FIG. 7 is a flowchart of a charge control process. Like numbers show like steps in FIG. 5. The charge control process of the first embodiment, as shown in FIG. 5, prohibits the charging of the battery 11 when NR>=NL (i.e. step 454 is “No”). In the charge control process of FIG. 7, the charging of the battery 11 is never prohibited, even when NR>=NL. That is steps 454, 458, and 459 are removed. Therefore, the travel control is mainly employed for restricting the travel function of the vehicle 10. Further, damage of the battery-driven device due to use of the battery-driven device is prevented by the restricted charge control.

### Other Embodiment

Although the present disclosure has been fully described in connection with preferred embodiment thereof with reference to the accompanying drawings, it is to be noted that various changes and modifications will become apparent to those skilled in the art.

For example, when the non-compliant battery is used the above embodiments describe that a charge amount of the battery 11 is controlled as a whole. Alternatively, the charge amount of the battery module 11a that were found to be non-compliant may only be controlled.

Further, by skipping steps 450, 453 to 458 of FIG. 5, the charging in steps 451 and 452 may be permitted, regardless of the authentication of the battery. Further, by skipping steps 453 to 457, the process in steps 458 and 459 may be performed when the authentication of the battery 11 is not established. In such a case, use of the non-compliant battery leads to prohibition of the charging of the battery 11, with a travel of the vehicle 10 permitted under a restricted condition.

Further, the function of the control unit may be provided solely by software, solely by hardware, or by combination of software and hardware. Further, the control unit may be provided as a digital circuit, or as an analogue circuit.

Further the control unit that sets the travel control of the battery-driven device to a normal travel control for a compliant battery and the restriction unit that sets the travel control of the battery-driven device to a restricted travel control for non-compliant battery may be configured as one control unit that performs the normal travel control and the restricted travel control based on the compliance of the battery.

Such changes, modifications, and summarized schemes are to be understood as being within the scope of the present disclosure as defined by appended claims.

What is claimed is:

1. A battery management apparatus comprising:
a battery-checker that determines if a battery in a battery-driven device is compliant or non-compliant;
a control unit that controls a functional index of the battery-driven device to a normal output when the battery is compliant; and
a restriction unit that controls the functional index of the battery-driven device to a restricted output when the battery is non-compliant, wherein the restricted output is different from the normal output, and the restricted output restricts the use of the battery-driven device when compared to the normal output by the control unit.

2. The battery management apparatus of claim 1, wherein:
the functional index of the battery-driven device includes an operation period and a capacity; and
the restriction unit restricts the operation period or the capacity or both the operation period and the capacity to control the battery-driven device to the restricted output.

3. The battery management apparatus of claim 2, wherein:
the restriction unit shortens the operation period of the battery-driven device when the battery is non-compliant, the operation period is shorter than an operation period set by the control unit.

4. The battery management apparatus of claim 3 where the restriction unit further includes:
a permission section that permits a battery operation of the battery-driven device until the battery-driven device exceeds the restriction output; and
a prohibition section that prohibits the battery operation of the battery-driven device when the battery-driven device exceeds the restriction output.

5. The battery management apparatus of claim 2, wherein
the restriction unit lowers the capacity of the battery-driven device when the battery is non-compliant, the capacity is lower than a capacity set by the control unit for the normal output.

6. The battery management apparatus of claim 1 wherein the restriction unit further includes:
a detection section that detects a battery condition; and
a configuration section that determines the restricted output based on the battery condition detected by the detection section.

7. The battery management apparatus of claim 1 further includes:
a compliant battery charge unit that charges the battery when the battery is compliant; and
a non-compliant battery charge unit that charges the battery that is non-compliant under a restricted charge condition that is stricter than a charge condition of the compliant battery charge unit.
